(19) United States
(12) Patent Application Publication
(10) Pub. No.: US 2022/0272269 A1
(43) Pub. Date: Aug. 25, 2022

(54) OCCUPANT MONITORING DEVICE FOR VEHICLE

(71) Applicant: SUBARU CORPORATION, Tokyo (JP)

(72) Inventors: Ryota NAKAMURA, Tokyo (JP); Taiyo MATSUHASHI, Tokyo (JP)

(21) Appl. No.: 17/671,964

(22) Filed: Feb. 15, 2022

(30) Foreign Application Priority Data
Feb. 24, 2021 (JP) 2021-027736

(51) Int. Cl. H04N 5/232; B60R 11/04; B60R 11/02; G06T 7/70; G06V 20/59

(52) U.S. Cl. CPC H04N 5/23299; B60R 11/04; B60R 11/0235; G06T 7/70; G06V 20/59; B60R 2011/0003

(57) ABSTRACT

An occupant monitoring device for a vehicle includes a user interface module including a display that displays a screen for one or more occupants in the vehicle, and an imager that captures one or more images for monitoring the one or more occupants in the vehicle, an actuator that drives the module to change an orientation of the module, and a controller that executes identification control and/or registration control for the one or more occupants. The controller executes a first control to cause the actuator to change the module's orientation so that the imager's orientation becomes close to an orientation of an occupant who gets into the vehicle, and executes the identification control and/or the registration control for monitoring the one or more occupants in the vehicle with captured image data obtained by the imager in a case where the first control has been executed to change the imager's orientation.

### CROSS-REFERENCE TO RELATED APPLICATIONS

The present application claims priority from Japanese Patent Application No. 2021-027736 filed on Feb. 24, 2021, the entire contents of which are hereby incorporated by reference.

### BACKGROUND

The disclosure relates to an occupant monitoring device for a vehicle.

In the field of vehicles, for example, a liquid crystal device including a touch panel is employed as a display for settings about a vehicle, that is, as a user interface. For example, this liquid crystal device displays operation objects such as buttons.

An occupant in the vehicle operates any operation object displayed on this liquid crystal device. A controller of the vehicle executes control depending on a type of operating action (hereinafter referred to as “operation type”).

This liquid crystal device allows various types of operation such as clicking on the operation object and swiping on the surface of the liquid crystal device as typified in mobile terminals. The occupant is familiar with those types of operation on mobile terminals.

In the field of vehicles, conditions of occupants may be monitored during driving assistance and autonomous driving (Japanese Unexamined Patent Application Publication Nos. 2019-014359 and 2019-014360).

To monitor occupants in the vehicle, the vehicle includes an imaging device on, for example, a dashboard in front of the occupants, and conditions of the occupants are determined based on an image captured by the imaging device.

### SUMMARY

An aspect of the disclosure provides an occupant monitoring device for a vehicle. The occupant monitoring device includes a user interface module including a display and an imager, an actuator, and a controller. The display is configured to display a screen for one or more occupants in the vehicle. The imager is configured to capture one or more images for monitoring the one or more occupants. The actuator is configured to drive the user interface module to change an orientation of the user interface module. The controller is configured to execute at least one of identification control and registration control for the one or more occupants. The controller is configured to execute a first control to cause the actuator to change the orientation of the user interface module so that an orientation of the imager becomes close to an orientation of an occupant who gets into the vehicle. The controller is configured to execute at least one of the identification control and the registration control for monitoring the one or more occupants in the vehicle by using captured image data obtained by the imager in a state where the first control has been executed to change the orientation of the imager.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to explain the principles of the disclosure.

FIG. 1 is a diagram illustrating an automobile including an occupant monitoring device according to an embodiment of the disclosure;

FIG. 2 is a diagram illustrating a control device of the automobile in FIG. 1;

FIG. 3 is a diagram illustrating the occupant monitoring device of the automobile in FIG. 2;

FIGS. 4A and 4B are diagrams illustrating normal internal disposition of a liquid crystal device including a display operation panel and a camera module including an imaging sensor in the occupant monitoring device in FIG. 3;

FIGS. 5A to 5D are diagrams illustrating how a driver of the automobile is imaged;

FIG. 6 is a diagram illustrating details of the liquid crystal device and the camera module of the occupant monitoring device at the center of a body in a vehicle width direction;

FIG. 7 is a flowchart of occupant monitoring control to be executed by a monitoring controller in FIG. 3;

FIG. 8 is a flowchart of a new occupant registration process in FIG. 7; and

FIG. 9 is a diagram illustrating a modified example of the liquid crystal device and the camera module of the occupant monitoring device at the center of the body in the vehicle width direction in FIG. 6.

### DETAILED DESCRIPTION

An imaging device may be provided near a liquid crystal device including a touch panel in a vehicle. Therefore, the imaging device can capture a frontal image of an occupant viewing a predetermined screen displayed on the liquid crystal device. When frontal image data of the occupant is provided in advance, the frontal image data is compared with, for example, current captured image data to determine conditions of the occupant such as a driver with higher probability.

For example, the liquid crystal device and the imaging device may be disposed at the center of the vehicle in a vehicle width direction. Therefore, not only the driver but also a passenger can view an image and operate the liquid crystal device including the touch panel. It is not desirable that the liquid crystal device and the imaging device be inclined toward the driver at the center of the vehicle in the vehicle width direction because the passenger's convenience may decrease.

When the liquid crystal device and the imaging device are fixed and oriented rearward at the center of the vehicle in the vehicle width direction, the driver and the passenger may be shown on the periphery of an image with a possibility of distortion rather than at the center of the image in the captured image data obtained by the imaging device. When occupant recognition is executed for the driver and other occupants based on the distorted image, it may be difficult to grasp, for example, detailed features of faces. Therefore, the occupant recognition performance may decrease.

It is desirable to improve disposition of an imager and other devices in an occupant monitoring device that monitors occupants in the vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

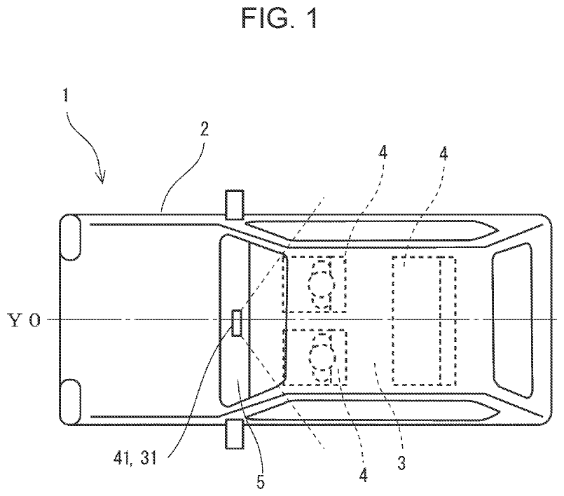

FIG. 1 is a diagram illustrating an automobile 1 including an occupant monitoring device 15 according to the embodiment of the disclosure.

The automobile 1 is an example of a vehicle. The automobile 1 may use an internal combustion engine, battery power, or a combination thereof as a traveling power source.

In FIG. 1, a body 2 of the automobile 1 has a cabin 3. The cabin 3 includes a plurality of front seats 4 as a driver's seat and a passenger's seat, and an elongated rear seat 4. Occupants including a driver sit on the seats 4. A dashboard 5 extending along a vehicle width direction of the body 2 is provided at the front of the cabin 3 that is an area in front of the front seats 4.

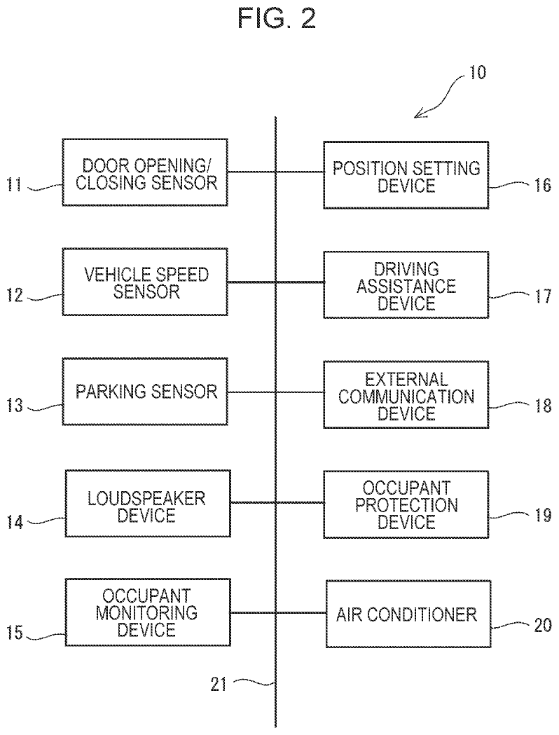

FIG. 2 is a diagram illustrating a control device 10 of the automobile 1 in FIG. 1.

In FIG. 2, the control device 10 includes a door opening/closing sensor 11, a vehicle speed sensor 12, a parking sensor 13, a loudspeaker device 14, the occupant monitoring device 15, a position setting device 16, a driving assistance device 17, an external communication device 18, an occupant protection device 19, an air conditioner 20, and an internal network 21 that couples those devices.

The internal network 21 may be a wired communication network such as a controller area network (CAN) and a local interconnect network (LIN) for the automobile 1. The internal network 21 may be a communication network such as a LAN, or a combination of those networks. A part of the internal network 21 may be a wireless communication network.

The door opening/closing sensor 11 detects opening and closing motions of doors of the automobile 1.

The vehicle speed sensor 12 detects a speed of the traveling automobile 1. The vehicle speed sensor 12 may detect a stopped state.

The parking sensor 13 detects a parked state in which the automobile 1 remains stopped. For example, the parking sensor 13 may detect the parked state based on either one of an operation on a select lever of transmission (not illustrated) for a parking position and an operation on a parking lever (not illustrated) for a braking position.

The occupant monitoring device 15 executes a process for recognizing an occupant in the cabin 3, for example, when the door opening/closing sensor 11 detects an opening or closing motion of the door.

When the occupant monitoring device 15 recognizes a plurality of occupants, the occupant monitoring device 15 may monitor the occupants individually.

The occupant monitoring device 15 may output information on the recognized occupants and information based on the monitoring to the individual parts of the control device 10 via the internal network.

For example, the occupant monitoring device 15 recognizes a driver on the driver's seat 4, and monitors either one of inattentive driving and drowse of the recognized driver. When the driver is in a predetermined state, the occupant monitoring device 15 executes control to caution the driver or avoid danger. The occupant monitoring device 15 may output information on the driver, information on the caution, and information on the danger avoidance to the individual parts of the control device 10 via the internal network.

For example, the loudspeaker device 14 outputs voice and alert sound. The loudspeaker device 14 may output alert generated for the driver and other occupants by the occupant monitoring device 15.

For example, the position setting device 16 adjusts longitudinal and vertical positions of the seats 4, angles of back rests, longitudinal and vertical positions and an angle of a steering wheel, and longitudinal and vertical positions and angles of various pedals. The position setting device 16 changes the positions of the seats based on occupant information output from the occupant monitoring device 15.

The driving assistance device 17 assists either one of driver's manual driving operations on the automobile 1 and autonomous driving operations of the automobile 1. The driving assistance device 17 controls acceleration, deceleration, stop, and steering of the automobile 1. The driving assistance device 17 executes driving assistance depending on the driver based on driver information output from the occupant monitoring device 15.

For example, the external communication device 18 establishes wireless communication channels with a base station on a public wireless communication network, a base station on a commercial wireless communication network, and a base station for advanced traffic information, and executes data communication by using the established wireless communication channels. For example, the external communication device 18 may execute interactive data communication with a server that assists autonomous driving. The external communication device 18 may transmit information on occupants including the driver from the occupant monitoring device 15 to the server as, for example, emergency assistance information.

The occupant protection device 19 executes occupant protection control when collision of the automobile 1 is detected or predicted. For example, the occupant protection device 19 protects an occupant on the seat 4 by inflating an airbag (not illustrated) or applying tension to a seatbelt. The occupant protection device 19 may protect the occupant based on the occupant information output from the occupant monitoring device 15.

The air conditioner 20 controls a temperature and an oxygen concentration in the cabin 3. For example, the air conditioner 20 adjusts the temperature in the cabin 3 to a set temperature by supplying cooled or heated air to the cabin 3. The air conditioner 20 may condition air based on the occupant information output from the occupant monitoring device 15.

For example, the occupant can ride with comfort under the occupant's settings through the control based on the occupant information output from the occupant monitoring device 15. For example, the driver can concentrate on driving of the automobile 1.

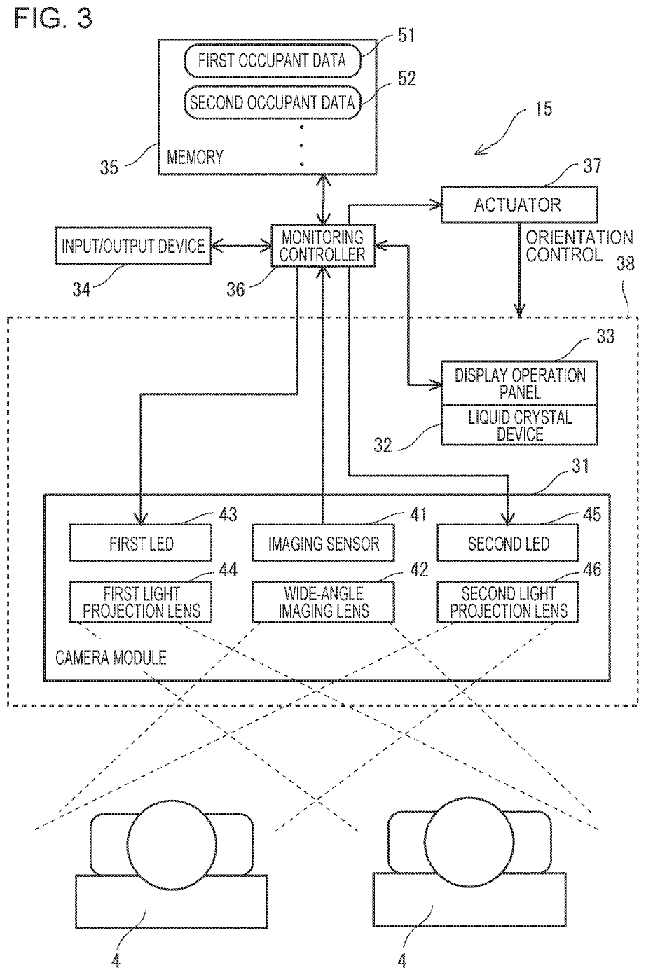

FIG. 3 is a diagram illustrating the occupant monitoring device 15 of the automobile 1 in FIG. 2. In FIG. 3, the occupant monitoring device 15 monitors not only the driver but also, for example, a plurality of occupants on the front seats 4. In FIG. 3, the occupant monitoring device 15 includes a camera module 31, a liquid crystal device 32 including a display operation panel 33, an input/output device 34, a memory 35, an actuator 37, and a monitoring controller 36 coupled to those devices.

The input/output device 34 is coupled to the internal network 21. The input/output device 34 inputs data from and outputs data to the other parts in the automobile 1 via the internal network 21.

The liquid crystal device 32 displays an image on a display surface of the display operation panel 33. The liquid crystal device 32 displays a screen to be viewed by each occupant in the automobile 1. Examples of the display screen include an operation screen to be operated by the occupant. In one embodiment, the liquid crystal device 32 may serve as a “display”.

The display operation panel 33 is a transparent or semi-transparent panel laid over the display surface of the liquid crystal device 32. In one embodiment, the display operation panel 33 laid over the display surface of the liquid crystal device 32 may serve as a “display”. The display operation panel 33 detects an occupant's operation on the display surface of the liquid crystal device 32. The display operation panel 33 may output a point of the occupant's operation on the display surface of the liquid crystal device 32 to the monitoring controller 36. The camera module 31 images a plurality of occupants on the front seats 4. The camera module 31 includes an imaging sensor 41, a wide-angle imaging lens 42, a first LED 43, a first light projection lens 44, a second LED 45, and a second light projection lens 46.

The imaging sensor 41 is an optical semiconductor sensor such as a CCD or CMOS sensor. For example, the imaging sensor 41 may have a substantially quadrangular light receiving surface where a plurality of light receiving elements are arrayed. The imaging sensor 41 may output captured image data including captured images to the monitoring controller 36.

The wide-angle imaging lens 42 is laid over the imaging sensor 41. The wide-angle imaging lens 42 may include a plurality of optical lenses to suppress distortion at the edge of each image.

The imaging sensor 41 and the wide-angle imaging lens 42 image a plurality of occupants in the automobile 1 to monitor conditions of the occupants. In one embodiment, the imaging sensor 41 and the wide-angle imaging lens 42 may serve as an “imager”.

The wide-angle imaging lens 42 may be such that either one of upper bodies and heads of a plurality of occupants on the front seats 4 can be imaged with the imaging sensor 41 provided, for example, at the center of the dashboard 5 in the vehicle width direction.

The first LED 43 and the second LED 45 may be semiconductor light emitting elements. In one example, the first LED 43 and the second LED 45 may serve as a light projector to project light toward occupants in the automobile 1 to be imaged by the imaging sensor 41. For example, the first LED 43 and the second LED 45 may project infrared rays. In this case, the imaging sensor 41 outputs captured image data including images captured by using the infrared rays to the monitoring controller 36. The first light projection lens 44 is laid over the first LED 43. The first light projection lens 44 may radiate light from the first LED 43 mainly toward the driver on the driver's seat 4. The second light projection lens 46 is laid over the second LED 45. The second light projection lens 46 may radiate light from the second LED 45 mainly toward an occupant on the passenger's seat 4. The second light projection lens 46 may diffuse and project light toward the occupant on the passenger's seat 4 and the driver on the driver's seat 4.

The actuator 37 drives the camera module 31 and the liquid crystal device 32 including the display operation panel 33. In one example, the camera module 31 may permanently be affixed to the back of the display operation panel 33 of the liquid crystal device 32 to serve as a user interface module 38.

The actuator 37 may drive the liquid crystal device 32 and the camera module 31 by driving the user interface module 38 to change its orientation.

The memory 35 stores programs and data. The memory 35 may include a non-volatile memory and a volatile memory. Examples of the non-volatile memory include an HDD, an SSD, and an EEPROM. Examples of the volatile memory include a RAM.

In the memory 35 of the occupant monitoring device 15, pieces of data on a plurality of occupants registered in the automobile 1 may be recorded while being managed for the individual occupants. FIG. 3 illustrates first occupant data 51 on a first occupant and second occupant data 52 on a second occupant. The plurality of pieces of occupant data constitute a database in the memory 35.

The occupant data such as the first occupant data 51 and the second occupant data 52 may include identification information unique to the occupant, registered captured image data obtained by imaging, for example, the head and eyes of the occupant by the imaging sensor 41, and various types of setting data on settings made by the occupant. For example, the setting data may include information on a position of the occupant's seat, an initial setting about ON/OFF of driving assistance, preferences on autonomous driving, a server to be used, and settings about occupant protection and air conditioning.

In one example, the memory 35 may serve as a recorder to record, as registered captured image data of each occupant, captured image data obtained by imaging a frontal view of the occupant by the imaging sensor 41 while a predetermined screen is displayed on the liquid crystal device 32.

The memory 35 may record occupant data about general unregistered occupants.

Examples of the monitoring controller 36 include an ECU, a CPU, and other microcomputers.

The monitoring controller 36 reads and executes a program in the memory 35. Thus, the monitoring controller 36 is implemented as a controller of the occupant monitoring device 15. The monitoring controller 36 executes control to identify or register an occupant in the automobile 1. For example, the monitoring controller 36 may execute control depending on an operation type determined as an occupant's operation on the operation screen of the liquid crystal device 32.

The monitoring controller 36 executes control to monitor conditions of an occupant when the occupant gets into the automobile.

At this time, the monitoring controller 36 may operate the actuator 37 as appropriate. The monitoring controller 36 monitors conditions of a plurality of occupants in the automobile 1 based on captured image data obtained by the imaging sensor 41. For example, the monitoring controller 36 executes a registration process and a monitoring process for an occupant in the automobile 1 to monitor the occupant. The monitoring controller 36 may identify occupants in the automobile 1, and execute the monitoring process for each identified occupant. In one example, the monitoring controller 36 may serve as a determiner to determine conditions of at least the driver, such as inattentive driving, drowse, and emergency, by using his/her registered captured image data in the memory 35 as determination reference data.

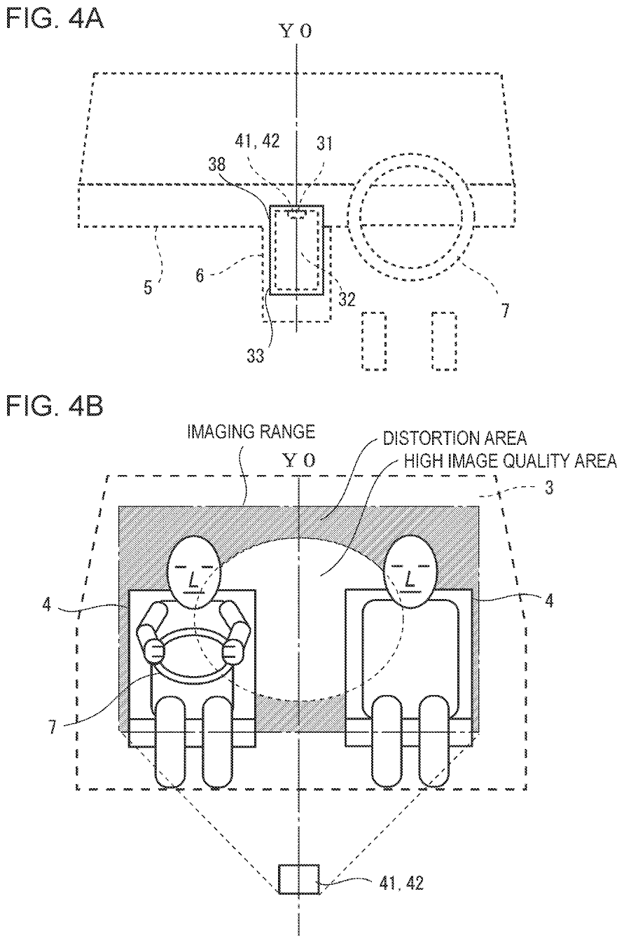

FIGS. 4A and 4B are diagrams illustrating normal internal disposition of the liquid crystal device 32 including the display operation panel 33 and the camera module 31 including the imaging sensor 41 in the occupant monitoring device 15 in FIG. 3.

FIG. 4A illustrates the dashboard 5 and a center console 6 at the front of the cabin 3.

For example, as illustrated in FIG. 1, the liquid crystal device 32 and the camera module 31 of this embodiment are disposed in a vertically oriented posture at the center of the automobile 1 in the vehicle width direction to extend from the dashboard 5 to the center console 6, and are oriented toward the rear of the automobile 1. Thus, the imaging sensor 41 of the camera module 31 can image the entire cabin including the driver and the passenger at a wide angle. The imaging sensor 41 may image the driver's upper body including the head and the passenger's upper body including the head to obtain one piece of captured image data.

The liquid crystal device 32 is disposed at the center of the automobile 1 in the vehicle width direction so that a center position Yd of the display screen in the vehicle width direction agrees with a center position Y0 of the automobile 1 in the vehicle width direction. The display screen of the liquid crystal device 32 can secure driver's visibility while securing passenger's visibility.

FIG. 4B is a diagram illustrating a cabin imaging range of the camera module 31 including the imaging sensor 41 and the wide-angle imaging lens 42 and oriented rearward at the center of the automobile 1 in the vehicle width direction.

The wide-angle imaging lens 42 is laid over the imaging sensor 41. Thus, the imaging sensor 41 can image the entire cabin including the driver and the passenger at a wide angle as in the imaging range illustrated in FIG. 4B. The imaging sensor 41 is disposed at the center of the automobile 1 in the vehicle width direction, and can image the head of the driver and the head of the passenger on the front seats 4.

When the wide-angle imaging lens 42 is combined with the imaging sensor 41 to image a plurality of occupants, an image at the center of the imaging range corresponds to a high image quality area with less distortion, and an image at the edge of the imaging range corresponds to a distortion area with more distortion than at the center. When the occupant is seated near the right or left end in the vehicle width direction, it may be difficult to image the head of the occupant without distortion. When determination is made based on, for example, whether the eyes of the occupant are open or closed, there is a possibility that conditions cannot correctly be determined based on the captured image data.

Unlike FIGS. 4A and 4B, the liquid crystal device 32 may be disposed so that the center position Yd of the display screen in the vehicle width direction is slightly shifted away from the driver relative to the center position Y0 of the automobile 1 in the vehicle width direction. In this case, the camera module 31 may be shifted similarly to the liquid crystal device 32, or the center position of the imaging sensor 41 may be set between the center position Yd of the display screen of the liquid crystal device 32 in the vehicle width direction and the center position Y0 of the automobile 1 in the vehicle width direction. At the shifted position, the liquid crystal device 32 and the imaging sensor 41 may be inclined toward the driver relative to a longitudinal direction of the body 2. Thus, the high image quality area at the center of the image captured by the imaging sensor 41 is shifted toward the driver. The imaging sensor 41 is likely to image the driver in the high image quality area at the center of the captured image rather than the distortion area on the periphery. It is expected that the driver can be imaged with less distortion.

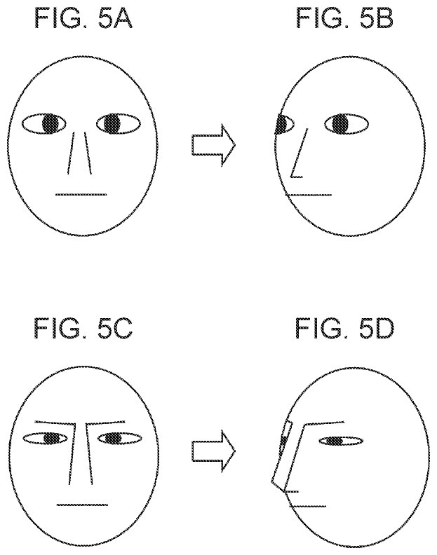

FIGS. 5A to 5D are diagrams illustrating how the driver of the automobile 1 is imaged.

FIG. 5A is a front view of the head of a first driver. FIG. 5B is a perspective view of the head of the first driver in FIG. 5A.

When the driver faces a forward side in the automobile 1, the imaging sensor 41 provided at the center of the automobile 1 in the vehicle width direction images the head of the driver obliquely as in FIG. 5B rather than imaging a frontal view of the head as in FIG. 5A.

FIG. 5C is a front view of the head of a second driver. FIG. 5D is a perspective view of the head of the second driver in FIG. 5C.

When the driver faces the forward side in the automobile 1, the imaging sensor 41 provided at the center of the automobile 1 in the vehicle width direction images the head of the driver obliquely as in FIG. 5D rather than imaging a frontal view of the head as in FIG. 5C.

Unlike captured image data in FIG. 5B, captured image data in FIG. 5D indicates that the right eye of the driver is hidden by the long nose of the driver and the image shows an iris.

In this case, it may be difficult for the monitoring controller 36 to determine whether the right eye of the driver is open or closed based on the captured image data in FIG. 5D. Particularly when a distorted image is captured unlike the undistorted image in FIG. 5D, it may be difficult for the monitoring controller 36 to determine whether the right eye of the driver is open or closed based on the captured image data in FIG. 5D.

Since the captured image data in FIG. 5D does not include an image component showing the white of the right eye of the driver enough to determine the conditions of the driver, it may be difficult for the monitoring controller 36 to extract the right eye condition based on the captured image data in FIG. 5D. When the monitoring controller 36 cannot determine the right eye, there is a possibility that the monitoring controller 36 cannot determine, for example, the orientation of the head of the driver. For example, when the area of the head in the image is determined based on a positional relationship between the eyes and the nose and a positional relationship between the eyes and the mouth, there is a possibility that the monitoring controller 36 cannot determine the orientation of the head of the driver based on the captured image data in FIG. 5D. Without reference data for the head of the driver, there is a strong possibility that the monitoring controller 36 cannot correctly estimate the conditions of the driver when the image component does not include the right eye of the driver.

The case of FIG. 5D may easily occur when the imaging sensor 41 of the camera module 31 is provided at the center of the automobile 1 in the vehicle width direction.

As described above, the occupants have individual differences such as big eyes, small eyes, projecting eyes, and sunken eyes.

The actual position of the head of the driver may move not only in an angle-of-view direction corresponding to the vehicle width direction, but also in a vertical direction. Considering those movements, it may be difficult to correctly estimate the conditions of the head and eyes of the driver based on current captured image data obtained by the imaging sensor 41.

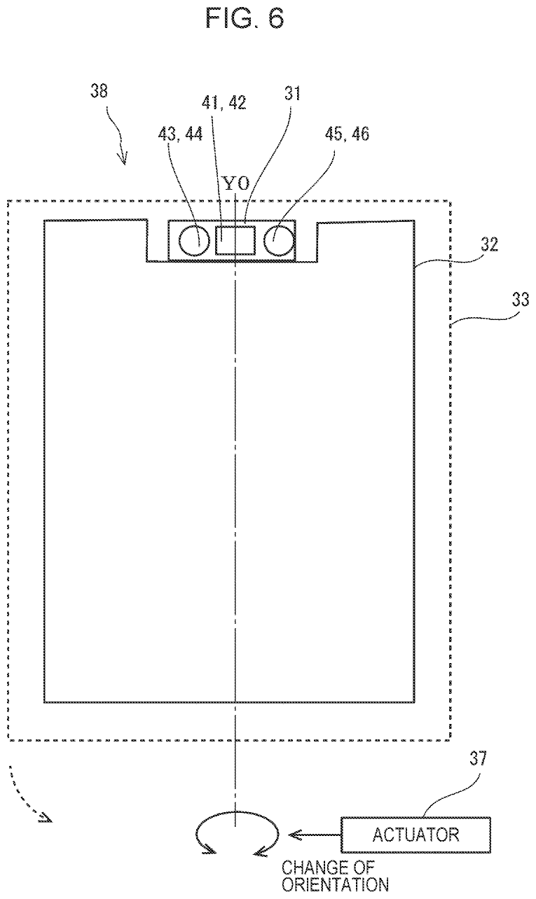

FIG. 6 is a diagram illustrating details of the liquid crystal device 32 and the camera module 31 of the occupant monitoring device 15 at the center of the body 2 in the vehicle width direction. FIG. 6 is a front view from the rear of the cabin 3. In FIG. 6, the center position of the display operation panel 33 of the liquid crystal device 32 agrees with the center position Y0 of the body 2 in the vehicle width direction. The liquid crystal device 32 and the camera module 31 are permanently affixed together as the user interface module 38.

The display surface of the liquid crystal device 32 serving as a screen display area is not quadrangular but is substantially recessed by cutting out the center of the upper edge of the quadrangle unlike general monitors.

On the back of the display operation panel 33, the camera module 31 including the imaging sensor 41 is disposed on the back of the recess above the display area of the liquid crystal device 32.

The center positions of the imaging sensor 41 and the wide-angle imaging lens 42 in the vehicle width direction agree with the center position of the display operation panel 33 of the liquid crystal device 32 and the center position Y0 of the body 2 in the vehicle width direction.

Thus, the imaging sensor 41 of the camera module 31 appears to be provided on the liquid crystal device 32. As a result, the imaging sensor 41 of the camera module 31 can image the occupant from the back of the liquid crystal device 32 including the display operation panel 33.

In the camera module 31, the imaging sensor 41 and the wide-angle imaging lens 42 are disposed at the center in the vehicle width direction. The first LED 43 and the first light projection lens 44 are disposed at an end near the passenger's seat. The second LED 45 and the second light projection lens 46 are disposed at an end near the driver. Thus, the camera module 31 can capture images by projecting light without being obstructed by an object such as a steering wheel 7 between the driver and the dashboard 5.

When the camera module 31 is provided on the back of the display operation panel 33, the wide-angle imaging lens 42, the first light projection lens 44, and the second light projection lens 46 may be provided by processing the display operation panel 33.

The user interface module 38 including the liquid crystal device 32 and the camera module 31 permanently affixed together is driven by the actuator 37 to turn about an axis along, for example, the vertical direction of the automobile 1. Thus, the orientation of the liquid crystal device 32 and the orientation of the camera module 31 are changed similarly. The actuator 37 may drive the user interface module 38 to turn not only about the axis at the center position Y0 of the user interface module 38 in the vehicle width direction, but also turn, for example, a passenger-side edge of the user interface module 38 about a driver-side edge of the user interface module 38. The user interface module 38 is movable at the center of the automobile 1 in the vehicle width direction.

In the user interface module 38, the liquid crystal device 32 can display, toward the driver and the passenger, not only a setting screen for occupant monitoring but also a navigation setting screen, a guidance screen, a contents display screen, and other screens.

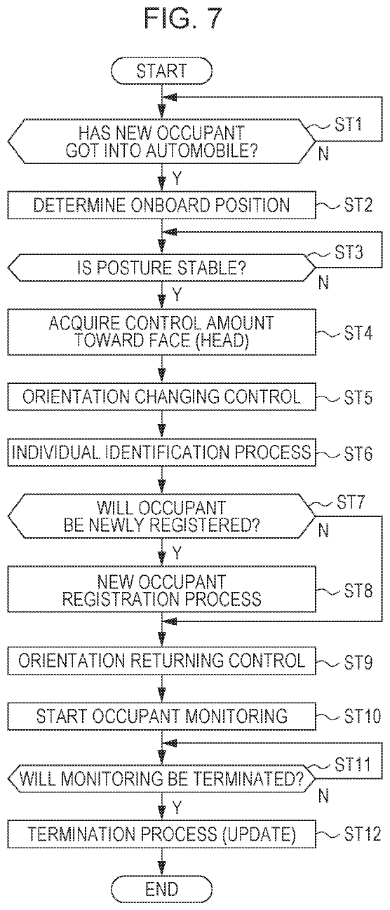

FIG. 7 is a flowchart of occupant monitoring control to be executed by the monitoring controller in FIG. 3.

The monitoring controller 36 may repeat the monitoring control in FIG. 7 when a new occupant gets into the automobile 1.

In Step ST1, the monitoring controller 36 determines whether a new occupant has got into the automobile 1. The occupant opens the door (not illustrated) of the automobile 1 and sits on the seat 4. For example, the monitoring controller 36 may make the determination by detecting that the new occupant gets into the automobile 1 based on a door opening/closing detection signal from the door opening/closing sensor 11. For example, the monitoring controller 36 may determine whether the new occupant has got into the automobile 1 based on the fact that the new occupant is shown in captured image data obtained by the imaging sensor 41. When no new occupant has got into the automobile 1, the monitoring controller 36 repeats this process. When the new occupant has got into the automobile 1, the monitoring controller 36 advances the process to Step ST2.

In Step ST2, the monitoring controller 36 determines an onboard position of the new occupant in the automobile 1. The monitoring controller 36 may determine the onboard position of the new occupant based on the fact that the new occupant is shown in the captured image data obtained by the imaging sensor 41.

In Step ST3, the monitoring controller 36 determines whether the new occupant is in a stable posture at the onboard position. The monitoring controller 36 may determine whether the new occupant is in a stable posture at the onboard position when the imaging position of the new occupant does not greatly change based on a plurality of pieces of captured image data obtained continuously by the imaging sensor 41. The monitoring controller 36 repeats this process until the posture is determined to be stable. When the posture is determined to be stable, the monitoring controller 36 advances the process to Step ST4.

In Step ST4, the monitoring controller 36 determines the position of either one of the face and the head of the new occupant based on the latest captured image data obtained by the imaging sensor 41, and calculates a control amount of the actuator 37 for satisfactorily imaging either one of the face and the head of the new occupant at the center of the image captured by the imaging sensor 41. The control amount of the actuator 37 includes a control amount in the vehicle width direction of the automobile 1. The control amount of the actuator 37 may further include a control amount in the vertical direction of the automobile 1. Thus, the monitoring controller 36 acquires a relative orientation of either one of the face and the head of the new occupant.

In Step ST5, the monitoring controller 36 operates the actuator 37 by the acquired control amount. Thus, the imaging sensor 41 and the liquid crystal device 32 of the user interface module 38 are oriented to face the face of the new occupant. That is, a light receiving surface of the imaging sensor 41 and a surface of a display panel of the liquid crystal device 32 of the user interface module 38 may be oriented to face the face of the new occupant. The actuator 37 is controlled to change the orientation of the user interface module 38 so that the orientation of the imaging sensor 41 becomes close to the orientation of the new occupant in the automobile 1 to agree with the acquired relative orientation.

In Step ST6, the monitoring controller 36 executes an individual identification process for the new occupant based on captured image data obtained by the imaging sensor 41 after the control. The monitoring controller 36 executes identification control for monitoring the occupant in the automobile 1 by using captured image data obtained by the imaging sensor 41 after the orientation of the user interface module 38 has been changed. The monitoring controller 36 may identify each occupant with high accuracy by comparing an occupant's image with less distortion at the center of the image in the captured image data with a plurality of pieces of occupant data recorded in the memory 35.

The monitoring controller 36 may turn ON the first LED 43 and the second LED 45 of the camera module 31. Thus, infrared rays are radiated onto either one of the upper body and the head of the occupant facing the liquid crystal device 32 to view a displayed guidance.

To identify the riding occupant, the monitoring controller 36 may acquire a new captured image from the imaging sensor 41, extract an image component of the riding occupant, and compare the image component with a plurality of pieces of occupant data registered in the memory 35. At this time, the monitoring controller 36 may make the comparison based on frontal image components in the pieces of registered captured image data of occupants in the memory 35. The frontal image tends to include salient features of, for example, the nose of the face. Even through the comparison based on the frontal image components, a match of the occupant can be determined with high accuracy. The monitoring controller 36 may compare the features extracted from the images instead of directly comparing the images.

When the registered captured image data in any occupant data registered in the memory 35 has a match at a predetermined probability or higher, the monitoring controller 36 may determine that the riding occupant is an occupant of the registered captured image data. In this case, the monitoring controller 36 identifies the riding occupant as an occupant identified through the comparison with the plurality of pieces of occupant data registered in the memory 35.

When the registered captured image data having a match at the predetermined probability or higher is not present in the plurality of pieces of occupant data registered in the memory 35, the monitoring controller 36 may identify the riding occupant as an unregistered occupant.

When there is an occupant whose occupant data is recorded in the memory 35, the monitoring controller 36 may execute a setting process by using the occupant data. The monitoring controller 36 outputs information on setting data to the individual parts of the automobile 1. Thus, processes are executed on, for example, a position of the occupant's seat, an initial setting about ON/OFF of driving assistance, preferences on autonomous driving, a server to be used, and settings about occupant protection and air conditioning. For example, the monitoring controller 36 determines whether a child bucket seat is set on the passenger's seat 4 based on the acquired latest captured image data. When the child bucket seat is set, the monitoring controller 36 makes a setting for prohibiting inflation of the airbag toward the passenger's seat 4.

In Step ST7, the monitoring controller 36 determines whether the new occupant will be registered. For example, the monitoring controller 36 causes the liquid crystal device 32 to display a confirmation screen for a registration process, and determines that the new occupant will be registered when the occupant has operated the screen on the display operation panel 33 to accept the registration. Then, the monitoring controller 36 advances the process to Step ST8. When the occupant has operated the screen to reject the registration, the monitoring controller 36 advances the process to Step ST9.

In Step ST8, the monitoring controller 36 executes a new occupant registration process. The monitoring controller 36 adds a record of the occupant data of the new occupant to the memory 35. The monitoring controller 36 executes the registration control for the occupant in the automobile 1 by using captured image data obtained by the imaging sensor 41 after the orientation of the user interface module 38 has been changed.

In Step ST9, the monitoring controller 36 returns the actuator 37 operated in Step ST5 by the acquired control amount. Thus, the imaging sensor 41 and the liquid crystal device 32 of the user interface module 38 are oriented toward the rear of the automobile 1.

In Step ST10, the monitoring controller 36 starts condition monitoring control for the occupant in the automobile 1. After the execution of the identification control and the registration control, the monitoring controller 36 controls the actuator 37 to return the orientation of the user interface module 38, and monitors the occupant by using captured image data obtained by the imaging sensor 41 after the return of the orientation. When a plurality of occupants are in the automobile 1, the monitoring controller 36 monitors conditions of the occupants through determination using the latest captured image data obtained by the imaging sensor 41 after the return of the orientation and pieces of registered occupant data of the occupants in the memory 35. The imaging sensor 41 of the user interface module 38 can image the cabin of the automobile 1 at a wide angle while being oriented toward the rear of the automobile 1 from the center of the automobile 1 in the vehicle width direction. The imaging sensor 41 can obtain captured image data for monitoring the occupants in the automobile 1.

For example, the monitoring controller 36 may determine image components of the upper body and the head of the occupant in the latest captured image data. The monitoring controller 36 determines the image components of the upper body and the head of the identified occupant in the latest captured image data by using, as a reference, image components in the registered captured image data of the occupant in the memory 35. For example, the monitoring controller 36 may estimate a frontal image of the occupant in the current captured image data obtained by the imaging sensor 41 based on a difference between a frontal image and a forward viewing image of the occupant registered in the memory 35, and determine conditions of the occupant in the automobile 1 based on the image components in the estimated frontal image of the occupant. For example, the monitoring controller 36 may correct lens distortion and direction of the occupant image in the current captured image data by using the registered frontal image of the occupant, and estimate the frontal image of the occupant in the current captured image data. When the registered captured image data is not found, the monitoring controller 36 may determine the image components of the upper body and the head of the occupant in the latest captured image data by using, as a reference, image components in standard registered captured image data in the memory 35.

Examples of the conditions of the occupant to be determined by the monitoring controller 36 in the latest captured image data include a direction of the head, a direction of the line of sight, and whether the eyes are open or closed. The monitoring controller 36 may determine pulsation in a vein. For example, when the eyes of the driver are closed, the direction of the line of sight is not the forward direction, the direction of the head is not the forward direction, or the pulsation is high, the monitoring controller 36 determines that the driver is not in a state appropriate for driving. In the other cases, the monitoring controller 36 may determine that the driver is in the state appropriate for driving. In one example, the monitoring controller 36 may serve as the determiner to determine the conditions of the occupant in the automobile 1 by using the registered captured image data recorded in the memory 35 as the reference data.

The monitoring controller 36 may determine at least one of the line of sight of the driver or whether the eyes of the driver are open or closed as the conditions of the driver in the automobile 1. Since the registered captured image data having high image quality can be used as the reference, the monitoring controller 36 can acquire not only the information on whether the eyes are open or closed but also, depending on the occupant, information on a change in the imaging condition of either one of the iris and the white of the eye between the top and bottom eyelids. Thus, an eye expression such as the direction of the line of sight of the occupant can be determined with high accuracy. If similar determination is attempted without using the registered captured image data of each occupant, the eye expression such as the direction of the line of sight of the occupant is determined, including individual differences such as the size of the eyes. It may be difficult to determine the eye expression of each individual with high accuracy. Excessive alert may be output based on the body feature of the occupant. The occupant may become uncomfortable.

The monitoring controller 36 may determine whether control on, for example, traveling of the automobile 1 is needed based on a result of the determination of the conditions of the occupant such as the driver. For example, when determination is made that the driver is not in the state appropriate for driving, the monitoring controller 36 determines that the control is needed, and executes the control on, for example, the traveling of the automobile 1. For example, when determination is made that the direction of the line of sight of the driver is not the forward direction or the direction of the head is not the forward direction, the monitoring controller 36 alerts the driver. For example, the driver may be alerted by displaying alert on the liquid crystal device 32 or outputting alert sound from the loudspeaker device 14. When determination is made that the driver does not view the forward side, that is, the line of sight of the driver is not yet the forward direction though the alert is output, the monitoring controller 36 may switch the traveling mode of the automobile 1 to the autonomous driving to decelerate or stop the traveling of the automobile 1.

When decelerating or stopping the traveling of the automobile 1, the monitoring controller 36 may turn ON a hazard warning signal lamp (not illustrated) or transmit emergency information by the external communication device 18. For example, when determination is made that the driver is drowsing or the pulsation is high, the monitoring controller 36 alerts the driver or decelerates or stops the traveling of the automobile 1. When decelerating or stopping the traveling of the automobile 1, the monitoring controller 36 may turn ON the hazard warning signal lamp (not illustrated) or transmit the emergency information by the external communication device 18. When the driver is continuously driving for a predetermined period or longer, the eyes are opened and closed at a predetermined frequency, or the head tends to bend downward, the monitoring controller 36 may determine that the control is needed, and prompt the driver to, for example, take a rest.

In Step ST11, the monitoring controller 36 determines whether to terminate the condition monitoring control for the occupant. The monitoring controller 36 may determine to terminate the condition monitoring control for the occupant when the automobile 1 is stopped and the ignition is turned OFF, the automobile 1 is stopped by arriving at a destination, or the occupant has got out of the automobile 1. For example, the monitoring controller 36 may determine whether the occupant gets out of the automobile 1 based on either one of an image obtained by the imaging sensor 41 and detection of door opening or closing by the door opening/closing sensor 11. When the condition monitoring control for the occupant is not terminated, the monitoring controller 36 repeats this process. When the condition monitoring control for the occupant is terminated, the monitoring controller 36 advances the process to Step ST12.

In Step ST12, the monitoring controller 36 executes a post-process of the occupant monitoring control.

For example, when each occupant gets out of the automobile 1, the monitoring controller 36 acquires setting information from the individual parts of the automobile 1, and updates the occupant data of each occupant that is registered in the memory 35. Thus, the occupant data registered in the memory 35 reflects the occupant's preferences. When the occupant gets in the automobile 1 next time, the latest occupant's settings are made automatically. The monitoring controller 36 may temporarily record occupant data of an unregistered occupant in the memory 35. When the occupant performs the registration operation later on, the settings can be linked immediately.

Then, the monitoring controller 36 terminates the monitoring control in FIG. 7.

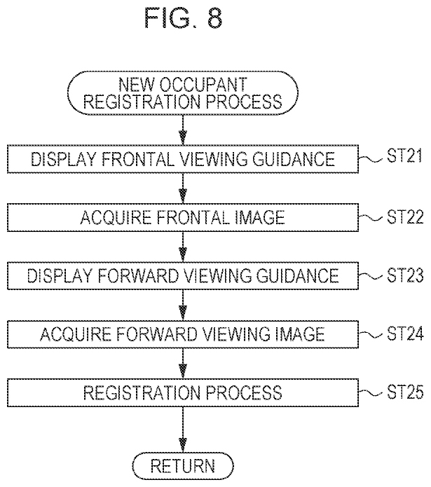

FIG. 8 is a flowchart of the new occupant registration process in FIG. 7.

In Step ST21, the monitoring controller 36 starts the registration process for a new occupant, and causes the liquid crystal device 32 to display frontal viewing guidance. The new occupant faces the liquid crystal device 32 with his/her face oriented thereto.

In Step ST22, the monitoring controller 36 newly acquires captured image data obtained by the imaging sensor 41 whose orientation is changed similarly to the liquid crystal device 32 to acquire a frontal image of the new occupant.

The monitoring controller 36 may turn ON the first LED 43 and the second LED 45 of the camera module 31. Thus, infrared rays are radiated onto either one of the upper body and the head of the occupant facing the liquid crystal device 32 to view the displayed guidance.

The frontal image is expected to include infrared image components of the eyes, nose, and mouth of the occupant with high probability. The infrared image components may include vein patterns of the head and eyeballs. Depending on the number of extracted features, the vein patterns of the head and eyeballs can be used for identifying individuals. The vein patterns of the head and eyeballs are hardly affected by a light and dark pattern caused by either one of the shape of the surface of the head and the bumps and dips and the shape of the face. The vein pattern of the eyeball may extend from the white of the eye on the periphery to the iris at the center. A vein pattern of the eyelid that covers the eyeball differs from the vein pattern of the eyeball. The monitoring controller 36 may extract information on the vein patterns of the head, eyeballs, and eyelids from the captured image data. The image component showing the frontal view of the head of the occupant is expected to include the image components of the parts of the head with high image quality.

The monitoring controller 36 may repeat either one of the guidance and the acquisition of the current captured image data from the imaging sensor 41 until the monitoring controller 36 determines that the frontal image includes the infrared image components of the eyes, nose, and mouth of the occupant.

In Step ST23, the monitoring controller 36 causes the liquid crystal device 32 to display forward viewing guidance. The new occupant faces the forward side in the automobile 1.

In Step ST24, the monitoring controller 36 newly acquires captured image data obtained by the imaging sensor 41 to acquire a forward viewing image of the new occupant.

The monitoring controller 36 turns ON the first LED 43 and the second LED 45 of the camera module 31. Thus, infrared rays are radiated onto either one of the upper body and the head of the occupant viewing the forward side in the automobile 1.

The forward viewing image may include infrared image components of the eyes, nose, and mouth of the occupant at angles different from those in the frontal image. The forward viewing image obtained by using the infrared rays may include the vein patterns of the head and eyeballs of the occupant viewing the forward side. The monitoring controller 36 may extract information on the vein patterns of the head, eyeballs, and eyelids from the captured image data.

The image component showing the head of the occupant viewing the forward side is expected to include, with high image quality, the image components of the parts of the head of the occupant viewing the forward side without drowse and inattentive driving. The image components of the parts of the head of the occupant viewing the forward side are appropriately associated with the image components of the parts of the head in the frontal view. For example, when there is an image of the head of a drowsing occupant viewing the forward side, image components of parts of the head of the drowsing occupant in a frontal view can be obtained by executing a process similar to that in a case where image components of the parts of the head of the occupant viewing the forward side without drowse and inattentive driving are converted into image components of the parts of the head in the frontal view. The image components of the parts of the head in the frontal view may indicate with high probability that the occupant is drowsing. This process can reduce the possibility of determination that the occupant is not drowsing in a case of a process executed uniformly irrespective of features of the occupant.

In Step ST25, the monitoring controller 36 additionally registers the occupant data of the new occupant in the memory 35, including the pieces of captured image data acquired in the process of Step ST21 to Step ST24.

Thus, the memory 35 records the frontal image and the forward viewing image of the new occupant.

In the embodiment described above, the imaging sensor 41 to be used for monitoring the occupant in the automobile 1 together with the liquid crystal device 32 that displays the screen for the occupant is provided as the user interface module 38 near the liquid crystal device 32. When executing either one of the identification control and the registration control for the occupant, the actuator 37 is controlled to change the orientation of the user interface module 38 so that the orientation of the imaging sensor 41 becomes close to the orientation of the new occupant in the automobile 1. Particularly at a home position of the imaging sensor 41 of the user interface module 38 where a plurality of occupants in the automobile 1 can be monitored, the relative orientation of either one of the face and the head of the new occupant is acquired after the determination about the detection of the new occupant getting into the automobile 1, the onboard position of the new occupant in the automobile 1, and whether the new occupant is in a stable posture at the onboard position, and the actuator 37 is controlled so that the orientation of the imaging sensor 41 agrees with the acquired relative orientation. Thus, the imaging sensor 41 can be oriented toward either one of the face and the head of the new occupant in the automobile 1. The monitoring controller 36 can execute either one of the identification control and the registration control for monitoring the occupant in the automobile 1 based on the image of the occupant such as the driver with less distortion by using the captured image data obtained by the imaging sensor 41 after the orientation of the user interface module 38 has been changed.

Thus, the monitoring controller 36 can execute either one of the identification control and the registration control for monitoring the occupant with the orientation of the imaging sensor 41 close to the orientation of the new occupant in the automobile 1.

For example, the occupant related to either one of the identification control and the registration control can be set close to the center of the screen and imaged with less distortion even if the user interface module 38 is provided at the center of the automobile 1 in the vehicle width direction and a plurality of occupants in the automobile 1 are monitored by imaging the cabin of the automobile 1 at a wide angle with the imaging sensor 41 of the user interface module 38 oriented rearward from the center of the automobile 1 in the vehicle width direction. The monitoring controller 36 can identify the occupant related to either one of the identification control and the registration control with higher probability by using the data on the occupant's image captured near the center of the image, desirably the data on the frontal image of the occupant.

In this embodiment, the disposition of, for example, the imaging sensor 41 of the occupant monitoring device 15 that monitors the occupant in the automobile 1 can be made appropriate for the occupant monitoring.

In this embodiment, the occupant such as the driver can be recognized based on the image with less distortion. Therefore, detailed features of the face and other parts of the occupant can easily be acquired with high accuracy. It is expected that the individual recognition performance can be improved even though the imaging sensor 41 is provided at the center in the vehicle width direction.

In this embodiment, after the execution of either one of the identification control and the registration control, the monitoring controller 36 controls the actuator 37 to return the orientation of the user interface module 38, and monitors the occupant in the automobile 1 by using the captured image data obtained by the imaging sensor 41 after the return of the orientation. For example, the returned orientation of the user interface module 38 may be such that the imaging sensor 41 is oriented toward the rear of the automobile 1. In this embodiment, the plurality of occupants in the automobile 1 can be monitored based on the captured image data obtained by imaging the cabin of the automobile 1 at a wide angle by the imaging sensor 41 at the center of the automobile 1 in the vehicle width direction. In this embodiment, the occupants can be monitored by imaging the occupants by the single imaging sensor 41. When monitoring the occupants, the imaging sensor 41 is stably oriented rearward, thereby reducing uncertainty and operation instability due to, for example, a difference in the orientation of the imaging sensor 41. The occupant in the automobile 1 is monitored by using the captured image data obtained by the imaging sensor 41 after the return of the orientation and the captured image data of the occupant that is acquired through either one of the identification control and the registration control. Even if the eyes of the occupant are not appropriately shown in the captured image data obtained by the imaging sensor 41 after the return of the orientation, the conditions of the occupant can be monitored with higher probability by, for example, complementing information based on the captured image data of the occupant that is acquired through either one of the identification control and the registration control.

The embodiment described above is an exemplary embodiment of the disclosure, but the embodiment of the disclosure is not limited to this embodiment, and various modifications and changes may be made without departing from the gist of the disclosure.

In the embodiment described above, the liquid crystal device 32 is disposed in the vertically oriented posture.

For example, the liquid crystal device 32 may be disposed in a horizontally oriented posture.

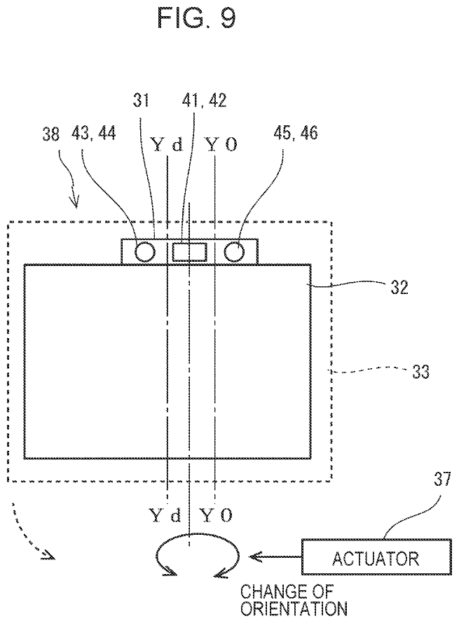

FIG. 9 is a diagram illustrating a modified example of the liquid crystal device 32 and the camera module 31 of the occupant monitoring device 15 at the center of the automobile 1 in the vehicle width direction in FIG. 6.

On the back of the display operation panel 33, the camera module 31 including the imaging sensor 41 is disposed above a quadrangular display area of the liquid crystal device 32.

In the embodiment described above, the display operation panel 33 of the liquid crystal device 32 and the imaging sensor 41 are disposed at the center of the automobile 1 in the vehicle width direction. The imaging sensor 41 has the wide-angle imaging lens 42 at the angle of view at which the heads of the plurality of occupants seated in the front row of the automobile can be imaged while being disposed at the center of the automobile 1 in the vehicle width direction. The monitoring controller 36 determines at least one of the line of sight of the occupant or whether the eyes of the occupant are open or closed as the conditions of the occupants in the automobile 1.

The occupant monitoring device may omit any one of the elements described above. For example, the occupant monitoring device may monitor the driver. Also in this case, the improvement in the probability of the monitoring determination is expected, for example, when the imaging sensor 41 is disposed on the back of the display operation panel 33 of the liquid crystal device 32 within a circumscribed circle of the image display area and the monitoring controller 36 determines the conditions of the occupant in the automobile 1 by using the registered captured image data recorded in the memory 35 as the reference data.

The occupant monitoring device 15 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the occupant monitoring device 15 including the monitoring controller 36. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. An occupant monitoring device for a vehicle, the occupant monitoring device comprising:
a user interface module comprising a display configured to display a screen for one or more occupants in the vehicle, and an imager configured to capture one or more images for monitoring the one or more occupants;
an actuator configured to drive the user interface module to change an orientation of the user interface module; and
a controller configured to execute at least one of identification control and registration control for the one or more occupants,
wherein the controller is configured to:
execute a first control to cause the actuator to change the orientation of the user interface module so that an orientation of the imager becomes close to an orientation of an occupant who gets into the vehicle; and
execute at least one of the identification control and the registration control for monitoring the one or more occupants in the vehicle by using captured image data obtained by the imager in a state where the first control has been executed to change the orientation of the imager.

2. The occupant monitoring device for the vehicle according claim 1, wherein the controller is configured to:
acquire a relative orientation of at least one of a face and a head of the occupant after execution of determination about at least one of
detection of the occupant getting into the vehicle,
an onboard position of the occupant in the vehicle, or
whether the occupant is in a stable posture at the onboard position; and
control the actuator so that the orientation of the imager agrees with the acquired relative orientation.

3. The occupant monitoring device for the vehicle according to claim 1,
wherein the user interface module is movable at a center of the vehicle in a vehicle width direction, and
wherein the controller is configured to monitor a condition of the one or more occupants based on the one or more images captured by the imager.

4. The occupant monitoring device for the vehicle according to claim 2,
wherein the user interface module is movable at a center of the vehicle in a vehicle width direction, and
wherein the controller is configured to monitor a condition of the one or more occupants based on the one or more images captured by the imager.

5. The occupant monitoring device for the vehicle according to claim 1, wherein the imager of the user interface module is configured to image a cabin of the vehicle at a wide angle while being oriented toward a rear of the vehicle from a center of the vehicle in a vehicle width direction to monitor a plurality of occupants in the vehicle.

6. The occupant monitoring device for the vehicle according to claim 2, wherein the imager of the user interface module is configured to image a cabin of the vehicle at a wide angle while being oriented toward a rear of the vehicle from a center of the vehicle in a vehicle width direction to monitor a plurality of occupants in the vehicle.

7. The occupant monitoring device for the vehicle according claim 1, wherein the controller is configured to, after execution of at least either one of the identification control and the registration control:
execute a second control to cause the actuator to return the orientation of the user interface module; and
monitor the one or more occupants by using captured image data obtained by the imager in a state where the second control has been executed to return the orientation of the imager.

8. The occupant monitoring device for the vehicle according claim 2, wherein the controller is configured to, after execution of at least either one of the identification control and the registration control:
execute a second control to cause the actuator to return the orientation of the user interface module; and
monitor the one or more occupants by using captured image data obtained by the imager in a state where the second control has been executed to return the orientation of the imager.

9. The occupant monitoring device for the vehicle according to claim 1, wherein the controller is configured to monitor the one or more occupants by using captured image data obtained by the imager after return of the orientation and captured image data of the one or more occupants that is acquired through at least one of the identification control and the registration control.

10. The occupant monitoring device for the vehicle according to claim 2, wherein the controller is configured to monitor the one or more occupants by using captured image data obtained by the imager after return of the orientation and captured image data of the one or more occupants that is acquired through at least either one of the identification control and the registration control.

11. The occupant monitoring device for the vehicle according to claim 1,
wherein the display and the imager are movable at a center of the vehicle in a vehicle width direction, and
wherein the controller is configured to monitor a condition of the one or more occupants in the vehicle based on the one or more images captured by the imager.

12. The occupant monitoring device for the vehicle according to claim 2,
wherein the display and the imager are movable at a center of the vehicle in a vehicle width direction, and
wherein the controller is configured to monitor a condition of the one or more occupants in the vehicle based on the one or more images captured by the imager.
